(19) United States
(12) Patent Application Publication
(10) Pub. No.: US 2013/0233989 A1
(43) Pub. Date: Sep. 12, 2013

(54) ELASTOMERIC COMPONENT CRADLE FOR AIRCRAFT AND OTHER VEHICLES

(71) Applicant: Robert G. Carpenter, Sammamish, WA (US)

(72) Inventor: Robert G. Carpenter, Sammamish, WA (US)

(21) Appl. No.: 13/415,591

(22) Filed: Mar. 8, 2012

(51) Int. Cl. F21V 21/00; F16M 13/02

(52) U.S. Cl. 248/231.81

(57) ABSTRACT

An elastomeric cradle forms an enclosure in which devices or instruments can be secured to an exterior surface of an aircraft or other vehicle. The elastomeric cradle is secured to an exterior of the aircraft with an adhesive. Elastomeric walls on the cradle are stretched to allow insertion and removal of a device from an enclosure in the cradle.

### FIELD OF DISCLOSED TECHNOLOGY

The present disclosed invention relates to instrument holders and in particular to cradles for securing devices to aircraft and other vehicles.

### BACKGROUND OF THE INVENTION

In general aviation, many pilots fly aircraft that were manufactured 10, 15 or even 25 years ago. Such aircraft typically lack all the currently available safety features. One example of such a feature is wingtip strobe lights, which are incorporated into newer aircraft. To add such features to older aircraft can be an expensive proposition. Wires typically need to be run from the cabin out to the wingtips and the devices need to be physically installed. Both operations can affect the physical integrity of the wing or other external surface. In addition, such retrofits typically need to be performed by a certified aircraft mechanic and can be time intensive to complete.

### BRIEF DESCRIPTION OF THE DRAWINGS

FIG. 1a illustrates an airplane on to which a device cradle in accordance with an embodiment of the described technology can be installed;

FIG. 1b illustrates a wingtip on to which a device cradle in accordance with an embodiment of the disclosed technology can be installed;

FIG. 2a illustrates an elastomeric device cradle in accordance with one embodiment of the disclosed technology;

FIG. 2b illustrates an underside of an elastomeric device cradle in accordance with an embodiment of the disclosed technology;

FIG. 3 illustrates a number of alternative devices that can be held in an elastomeric device cradle; and

FIG. 4 illustrates a representative device that can be secured in an elastomeric device cradle in accordance with the disclosed technology.

### DETAILED DESCRIPTION

As will be described in further detail below, the technology described herein relates to cradles or holders for securing devices to an exterior surface of a vehicle such as an aircraft or boat. In one embodiment, the cradle comprises a planar base having an upper and lower surface. An enclosure is formed on the upper surface of the base between a number of sidewalls that define the perimeter of the enclosure. In one embodiment, the sidewalls include a lip that extends partially over an opening of the enclosure.

During use, a device to be secured to an aircraft is inserted into the enclosure by stretching the elastomeric sidewalls and sliding the device into the enclosure. Upon release of the elastomeric sidewalls, the compressive tension of the elastomeric sidewalls and lip secures the device into the cradle.

In one embodiment, the cradle is secured to an aircraft or the vehicle with adhesive. In one embodiment, a bottom surface of the bottom sheet includes one or more dimples or recesses to aid in adhesively securing the cradle to the aircraft.

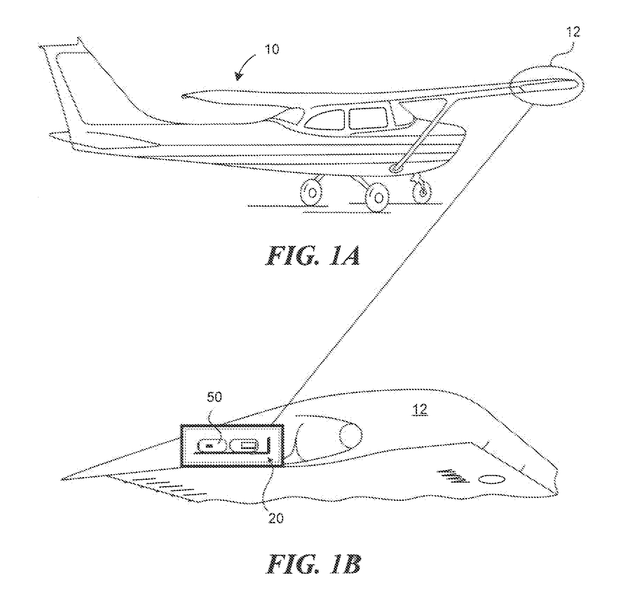

FIG. 1a illustrates a typical aircraft 10 used in general aviation. The aircraft 10 may not include all the currently available safety devices or other instruments that the owner of the aircraft would like. As indicated above, it can be cost prohibitive to retrofit older aircraft with these additional devices or instruments. In addition, such retrofitting can affect the structural integrity of the wings or other exterior surfaces of the aircraft.

To address this problem, the disclosed technology relates to a holder or cradle that can be used to secure a device to the exterior of an aircraft or other vehicle. In the example shown in FIG. 1a, it is desired to secure a strobe light to a wingtip 12 of the aircraft 10. As shown in FIG. 1b, a cradle 20 constructed in accordance with an embodiment of the disclosed technology is adhesively secured to the wingtip 12. The cradle 20 holds a strobe light 50 or other device securely to the aircraft. In one embodiment, the strobe light 50 or other device is battery powered so that no wires are required to extend from the cradle 20 to either power the device or to retrieve data from it.

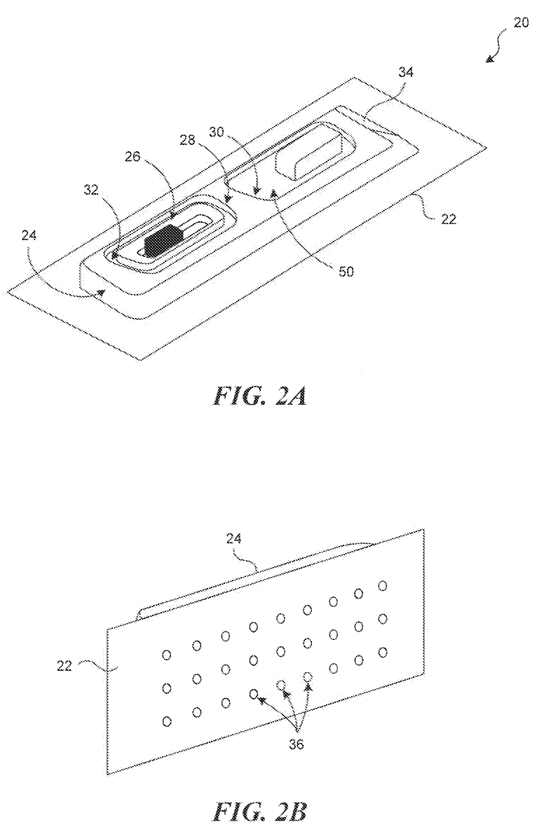

FIGS. 2a and 2b illustrate further detail of a cradle constructed in accordance with an embodiment of the disclosed technology. The cradle 20 is preferably made of an injection molded silicon rubber or other elastomeric material. In one embodiment, the cradle 20 includes a generally flat base 22 having an upper and lower surface. The lower surface of the base is configured to be adhesively secured to the aircraft or other vehicle in the manner described below. In one embodiment, the base 22 is generally rectangular however, other shapes (e.g., oval, triangular, etc.) are contemplated. In one embodiment, the base 22 is approximately four inches wide and 10 inches long and 1/16 inch thick.

Extending from the base 22 is an elastomeric sidewall 24 that defines the outer perimeter of an enclosure in which a device can be inserted. In one embodiment, the length and width of the elastomeric sidewalls 24 is smaller than the length and width of the base 22 so that an area of the base extends beyond the borders of the sidewalls. A hollow space between the interior of the sidewalls 24 defines the enclosure in which a device is inserted and held by the cradle. In one embodiment, the sidewalls 24 include a lip 26 at an outer edge of the sidewalls. The lip surrounds the perimeter of the sidewalls and extends partially into an opening of the enclosure. In the embodiment shown, a cradle 20 also includes a band 28 that is positioned approximately midway along the opening of the enclosure. The band 28 extends across the width of the enclosure thereby connecting the sidewalls 24 surfaces on either side of the enclosure. The band 28 therefore divides the opening of the enclosure into a first window 30 and a second window 32, and can aid in securing a device in the enclosure.

A device 50 is placed in the enclosure by stretching the sidewalls 24, lip 26 and the band 28 of the cradle and inserting the device through one of the windows 30, 32. Upon release of the elastomeric sidewalls 24, lip 26 and the band 28, the device is securely held within the enclosure of the cradle 20 by the elastomeric force of the cradle.

To remove the device, the reverse process is performed whereby the elastomeric sidewall 24, lip 26 and the band 28 are elastomerically deformed and the device 50 is pulled out through one of the windows 30, 32.

It should be noted that in some embodiments, the band 28 extending across the opening may not be necessary depending upon the forces to which the cradle 20 and the enclosed device 50 are exposed. In one embodiment, a leading edge 34 of the sidewall 24 is sloped or otherwise aerodynamically shaped to reduce resistance of the cradle to an air stream occurring during flight. In one embodiment, the height of the sidewall 24 is approximately 0.75 inches in order to minimize aerodynamic drag.

FIG. 2b illustrates a bottom surface of the base 22 supporting the cradle 20. In one embodiment, the bottom surface includes a number of inwardly concaved dimples 36 or other recesses that aid in adhesively securing the cradle to an exterior surface of an aircraft or other vehicle.

In one embodiment, the elastomeric cradle 20 is secured to an aircraft with an adhesive such as MIL-A-46146B RTZ adhesive available as Dow Corning 3145 Silicon Adhesive. In one installation technique, adhesive is applied to the surface of the aircraft and/or the bottom surface of the cradle 20 and the two coated surfaces are pressed together. A roller (not shown) rolls over the top of the surface of the base in order to enhance the adhesive bond between the cradle and the aircraft/vehicle.

As will be appreciated, the cradle 20 is not limited to holding only strobe lights. Other devices such as sensors and instruments can be designed to fit in the enclosure of the cradle.

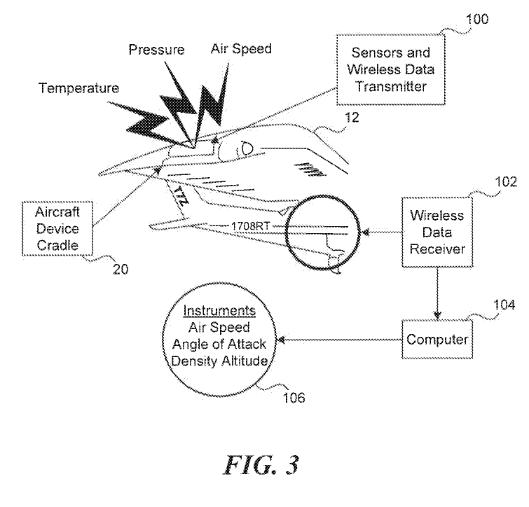

FIG. 3 illustrates an embodiment where an elastomeric cradle 20 is secured on a wingtip 12 of an aircraft. The elastomeric cradle 20 is configured to secure one of a number of devices including aircraft sensors and wireless data transmitters. The sensors can include temperature, pressure, airspeed, angle of attack or the like. Typically the sensors include a wireless data transmitter 100 and receiver so that data detected by the sensors can be transmitted to a wireless data receiver 102 within the cockpit of the aircraft. The wireless data receiver 102 in the aircraft can supply the received data to a computer 104, which in turn conditions and supplies the received data to one or more instruments 106 of the aircraft for the pilot to view.

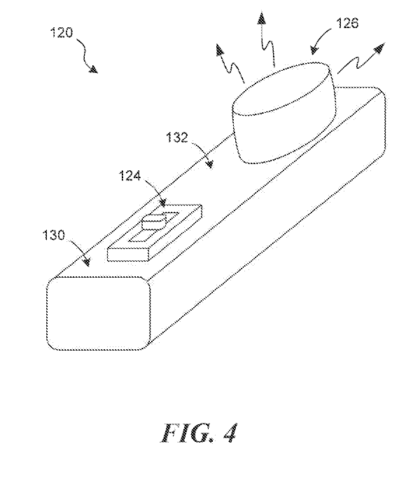

FIG. 4 illustrates a representative device 120 that is adapted to be secured within a cradle 20 constructed in accordance with the disclosed technology. In the embodiment shown, the device 120 is generally rectangular in shape with outer dimensions sized to fit within the enclosure of the cradle 20. The device 120 includes an on/off switch 124 and a strobe light 126. Both the on/off switch 124 and the strobe light 126 are positioned to extend through the windows 30, 32 of the enclosure when the device 120 is installed in the cradle 20. A space 130 surrounds the on/off switch 124 and the strobe light 126 to allow the lip 26 to cover the device 120. The on/off switch 124 and the strobe light 126 are separated by a space 132 that allows the band 28 of the cradle 20 to lie across the device 120 and not to interfere with either the on/off switch 124 or the strobe light 126. In one embodiment, the device 120 is battery powered but other power sources such as solar or wind power could be used. Although the device 120 shown is a strobe light 126, it will be appreciated that other devices such as temperature, pressure, airspeed, GPS devices/sensors, etc., could be used.

Although the disclosed embodiments emphasize their use on aircraft, it will be appreciated that the elastomeric cradle and mating devices can be used on other vehicles such as automobiles, boats, recreational vehicles and the like.

From the foregoing, it will be appreciated that specific embodiments of the invention have been described herein for purposes of illustration, but that various modifications may be made without deviating from the scope of the invention. For example, in one alternative embodiment, the base of the cradle may have two or more enclosures thereon. Accordingly, the invention is not limited except as by the appended claims.

I/we claim:

1. An elastomeric cradle for securing a device to an aircraft, comprising:
an elastomeric base having a top surface and a bottom surface, wherein the bottom surface can be adhesively secured to a surface on the aircraft;
an elastomeric sidewall extending outwardly from the top surface of the base, wherein a space between the sidewalls defines an enclosure into which a device can be inserted and wherein the sidewall can be elastically deformed such that a device can be fitted into the enclosure and secured therein.

2. The elastomeric cradle of claim 1, wherein the bottom surface of the base contains a number of concave depressions.

3. The elastomeric cradle of claim 1, wherein the sidewall includes a lip that extends over a portion of the enclosure.

4. The elastomeric cradle of claim 3, wherein the cradle includes a band that extends across an opening of the enclosure and joins opposite lip surfaces of the sidewall.

5. The elastomeric cradle of claim 1, wherein the sidewall includes a leading surface that is aerodynamically shaped to reduce drag on the cradle.

6. The elastomeric cradle of claim 1, wherein the cradle is made of silicone rubber.

7. The elastomeric cradle of claim 1, wherein the sidewalls of the cradle have a length and width that is smaller than a length and width of the base such that a portion of the base extends beyond the borders of the sidewalls.

8. The elastomeric cradle of claim 1, wherein the enclosure is adapted to receive a strobe light.

9. The elastomeric cradle of claim 1, wherein the enclosure is adapted to receive a sensor.

10. An elastomeric cradle for securing a device to a vehicle, comprising:
an elastomeric base having a top surface and a bottom surface, wherein the bottom surface of the base can be adhesively secured to a surface of the vehicle;
an elastomeric sidewall extending outwardly from the top surface of the base, wherein a space between the sidewalls defines an enclosure into which a device can be inserted and wherein the sidewall can be elastically deformed such that a device can be fitted into the enclosure and secured therein.

11. A device adapted to be fitted to a vehicle comprising:
a cradle that is secured to a vehicle, wherein the cradle is of the type having an elastomeric base with a top surface and a bottom surface, wherein the bottom surface of the base can be adhesively secured to a surface of the vehicle and an elastomeric sidewall extending outwardly from the top surface of the base, wherein a space between the sidewalls defines an enclosure into which a device can be inserted and wherein the sidewall can be elastically deformed such that a device can be fitted into the enclosure and secured therein; and
wherein the device includes a body having exterior dimensions adapted to fit within the enclosure of the cradle; and
an on/off switch positioned on a top surface of the body such that when the device is inserted into the enclosure of the cradle the on/off switch extends beyond the lip of the sidewalls and out of the cradle.

12. The device of claim 11, wherein the device is a strobe light and includes a light source, wherein the light source is positioned on a top surface of the device such that the light source extends beyond the lip of the sidewalls and out of the cradle.

13. The device of claim 12, wherein the cradle is of the type that includes a band that extends across an opening of the enclosure and the on/off switch and the light source are spaced apart such that the band fits between the on/off switch and the light source.
